(19) United States
(12) Patent Application Publication
(10) Pub. No.: US 2026/0322323 A1
(43) Pub. Date: Oct. 15, 2026

(54) SOLAR ENERGY UTILIZATION DEVICE

(71) Applicant: BOLY MEDIA COMMUNICATIONS (SHENZHEN) CO., LTD., Shenzhen, Guangdong (CN)

(72) Inventor: Xiaoping Hu, Shenzhen, Guangdong (CN)

(21) Appl. No.: 19/484,880

(22) PCT Filed: May 18, 2024
(86) PCT No.: PCT/CN2024/094089

§ 371 Date: Nov. 17, 2025

(30) Foreign Application Priority Data
May 18, 2023 (CN) 202310566371.5

(51) Int. Cl. H02S 40/22; H02S 40/42

(52) U.S. Cl. CPC H02S 40/22; H02S 40/425

(57) ABSTRACT

A solar energy utilization device, comprising a cover (300), two double-sided light energy utilization units (100, 200), and a concentrating mirror structure (400). A first light energy utilization portion (110) of the first double-sided light energy utilization unit (100) faces the cover (300); the second double-sided light energy utilization unit (200) is arranged perpendicular to the first double-sided light energy utilization unit (100); at least part of the concentrating mirror structure (400) is located on the side of the first double-sided light energy utilization unit (100) facing away from the cover (300), and is used for enabling light to converge to a second light energy utilization portion (120) of the first double-sided light energy utilization unit (100) and enabling light to converge to at least one light energy utilization portion (210, 220) of the second double-sided light energy utilization unit (200).

### TECHNICAL FIELD

The present disclosure relates to the technical field of solar photovoltaic systems, and in particular, to solar energy utilization devices.

### BACKGROUND OF THE DISCLOSURE

Current solar energy utilization devices utilize horizontally or vertically arranged photovoltaic panels. Panels placed horizontally exhibit higher power generation efficiency around midday when solar irradiance is strong, but lower efficiency in the morning and afternoon. Vertically arranged photovoltaic panels, conversely, demonstrate the opposite characteristic. This discrepancy stems from the poor adaptability of these devices to variations in the solar angle throughout the day. Consequently, they are unable to sustain a relatively high average power generation output over the course of a day, leading to a low light energy utilization rate.

### SUMMARY OF THE DISCLOSURE

The present disclosure provides a solar energy utilization device that solves the problems of poor adaptability to sunlight angle variations, low power generation, and low light energy utilization efficiency in conventional solar energy utilization devices.

A solar energy utilization device provided according to the present disclosure may include: a cover, at least a portion of which is transparent or semi-transparent; a first double-sided light energy utilization unit, arranged on one side of the cover, and having a first light energy utilization part and a second light energy utilization part that are arranged in opposite directions, wherein the first light energy utilization part of the first double-sided light energy utilization unit faces the cover; a second double-sided light energy utilization unit, arranged perpendicularly to the first double-sided light energy utilization unit, and having a first light energy utilization part and a second light energy utilization part that are arranged in opposite directions, wherein the first light energy utilization part and the second light energy utilization part are configured to receive and convert solar energy; and a concentrating mirror structure, at least a portion of which is arranged on a side of the first double-sided light energy utilization unit away from the cover, and which is configured to converge light onto the second light energy utilization part of the first double-sided light energy utilization unit, and onto the first light energy utilization part and/or the second light energy utilization part of the second double-sided light energy utilization unit.

In some embodiments, an end of the second double-sided light energy utilization unit is in thermal contact with the second light energy utilization part of the first double-sided light energy utilization unit to conduct heat from the first double-sided light energy utilization unit to the second double-sided light energy utilization unit; and another end of the second double-sided light energy utilization unit is extended away from the first double-sided light energy utilization unit and is in thermal contact with the concentrating mirror structure.

In some embodiments, the second double-sided light energy utilization unit is arranged between the first double-sided light energy utilization unit and the cover, an end of the second double-sided light energy utilization unit is in thermal contact with the first light energy utilization part of the first double-sided light energy utilization unit, and the second light energy utilization part of the first double-sided light energy utilization unit is in thermal contact with the concentrating mirror structure.

In some embodiments, the first double-sided light energy utilization unit is arranged on the cover and is in thermal contact or thermal isolation with the cover, or an end of the second double-sided light energy utilization unit is faced toward the cover so as to be in thermal contact or thermal isolation with the cover; the concentrating mirror structure is in thermal contact or thermal isolation with the cover.

In some embodiments, the solar energy utilization device may further comprise a cooling container arranged on a side of the concentrating mirror structure away from the cover; wherein the cooling container is provided inside with an accommodation tank and an external interface; the accommodation tank is configured to accommodate a cooling working fluid; the external interface is configured for the cooling working fluid to enter and exit the accommodation tank; and the concentrating mirror structure is capable of being in contact with the cooling working fluid to transfer heat to the cooling working fluid.

In some embodiments, the second double-sided light energy utilization unit is in thermal contact with the concentrating mirror structure;

or, the first double-sided light energy utilization unit is in thermal contact with the concentrating mirror structure.

In some embodiments, a connection point where the second double-sided light energy utilization unit is in thermal contact with the concentrating mirror structure is provided with a perforation, wherein the perforation is configured for the cooling working fluid to come into contact with the second double-sided light energy utilization unit, so that the second double-sided light energy utilization unit is capable of directly transferring heat to the cooling working fluid;

or, a connection point where the first double-sided light energy utilization unit is in thermal contact with the concentrating mirror structure is provided with an opening, wherein the opening is configured for the cooling working fluid to come into contact with the first double-sided light energy utilization unit, so that the first double-sided light energy utilization unit is capable of directly transferring heat to the cooling working fluid.

In some embodiments, the cover and the concentrating mirror structure are enclosed to form a cavity, wherein the cavity is configured for accommodating a cooling medium; and the first double-sided light energy utilization unit and the second double-sided light energy utilization unit are capable of transferring heat to the cooling medium.

In some embodiments, the solar energy utilization device may further comprise a thermal functional layer, wherein at least a portion of the thermal functional layer is transparent or semi-transparent; the thermal functional layer is arranged on the cover, or arranged between the cover and the first double-sided light energy utilization unit, or arranged between the cover and the second double-sided light energy utilization unit, or arranged between the cover and the concentrating mirror structure; the thermal functional layer is configured to block or connect heat transfer.

A solar energy utilization device also provided according to the present disclosure may include: a cover, at least a portion of which is transparent or semi-transparent; a first double-sided light energy utilization unit, arranged on the cover, and having a first light energy utilization part and a second light energy utilization part that are arranged in opposite directions; wherein the first light energy utilization part is faced toward the cover; a second double-sided light energy utilization unit, having an end connected to the first double-sided light energy utilization unit and another end extended in a direction away from the first double-sided light energy utilization unit; wherein the second double-sided light energy utilization unit has a first light energy utilization part and a second light energy utilization part that are arranged in opposite directions and are configured to receive and convert solar energy; and a concentrating mirror structure, at least part of which is arranged on a side of the first double-sided light energy utilization unit away from the cover, and which is configured for concentrating light onto the second light energy utilization part of the first double-sided light energy utilization unit, and onto the first light energy utilization part and/or the second light energy utilization part of the second double-sided light energy utilization unit, and the concentrating mirror structure is in thermal contact with the second double-sided light energy utilization unit.

A solar energy utilization device yet also provided according to the present disclosure may include: a cover, at least a portion of which is transparent or semi-transparent; a first double-sided light energy utilization unit, having a first light energy utilization part and a second light energy utilization part that are arranged in opposite directions; wherein the first light energy utilization part is faced toward the cover; a second double-sided light energy utilization unit, being perpendicular to the first double-sided light energy utilization unit, and arranged between the first double-sided light energy utilization unit and the cover, wherein an end of the second double-sided light energy utilization unit is connected to the first double-sided light energy utilization unit, and another end is extended in a direction away from the first double-sided light energy utilization unit; the second double-sided light energy utilization unit has a first light energy utilization part and a second light energy utilization part that are arranged in opposite directions and are configured to receive and convert solar energy; and a concentrating mirror structure, at least part of which is arranged on a side of the first double-sided light energy utilization unit away from the cover, wherein the concentrating mirror structure is configured to converge light onto the second light energy utilization part of the first double-sided light energy utilization unit, as well as onto the first light energy utilization part and/or the second light energy utilization part of the second double-sided light energy utilization unit, and the concentrating mirror structure is in thermal contact with the first double-sided light energy utilization unit.

According to the above embodiments, the solar energy utilization device includes a cover, a first double-sided light energy utilization unit, a second double-sided light energy utilization unit, and a concentrating mirror structure. At least a portion of the cover is transparent or semi-transparent; the first double-sided light energy utilization unit is arranged on one side of the cover; both the first double-sided light energy utilization unit and the second double-sided light energy utilization unit have a first light energy utilization part and a second light energy utilization part that are arranged away from each other, and the first light energy utilization part is faced toward the cover. The second double-sided light energy utilization unit is perpendicular to the first double-sided light energy utilization unit. At least part of the concentrating mirror structure is arranged on the side of the first double-sided light energy utilization unit away from the cover, and the concentrating mirror structure is configured to converge light onto the second light energy utilization part of the first double-sided light energy utilization unit, as well as onto the first light energy utilization part and/or the second light energy utilization part of the second double-sided light energy utilization unit. As a result, when sunlight is incident obliquely on the side of the first or second double-sided light energy utilization unit, the light is refracted to the concentrating mirror structure, which then refracts and converges the light onto both units, maximizing light energy utilization. This design provides strong adaptability to sunlight angle variations, helping maintain relatively high average power generation and light energy utilization efficiency throughout the day.

### BRIEF DESCRIPTION OF THE DRAWINGS

FIG. 1 is a vertical cross-sectional view of the concentrating solar energy utilization device according to a first embodiment of the present application;

FIG. 2 is a vertical cross-sectional view of the concentrating solar energy utilization device according to a second embodiment of the present application;

FIG. 3 is a vertical cross-sectional view of the concentrating solar energy utilization device according to a third embodiment of the present application; and

FIG. 4 is a vertical cross-sectional view of the concentrating solar energy utilization device according to a fourth embodiment of the present application.

### DETAILED DESCRIPTION

Specific embodiments of the present disclosure will now be described in detail with reference to the accompanying drawings. Similar or related components in different embodiments are labeled with associated reference numerals. The following embodiments include detailed descriptions to facilitate understanding of the present disclosure. However, those skilled in the art will readily recognize that certain features may be omitted under specific circumstances or substituted by other components, materials, or methods. In some instances, certain operations related to the present disclosure are not explicitly described or illustrated herein. This intentional exclusion is intentional to avoid obscuring the core technical solutions of the present disclosure. For those skilled in the art, a complete understanding of these operations can be attained through the descriptions provided in this specification and general technical knowledge in the art.

Additionally, the features, operations, or characteristics described in the specification may be combined in any suitable manner to form various embodiments. Similarly, steps or actions in the method descriptions may be reordered or modified in ways that would be obvious to those skilled in the art. Therefore, the sequences presented in the specification and drawings are intended solely to clarify the description of specific embodiments and do not imply mandatory orderings, unless explicitly stated that a particular sequence is required.

The numerical designations assigned to components herein, such as “first”, “second”, and the like, are used solely to distinguish between the described objects and carry no implication of order or technical significance. The terms “connected” and “coupled” as used in this application, unless otherwise specified, encompass both direct and indirect connections.

In some embodiments of the present disclosure, a solar energy utilization device is provided.

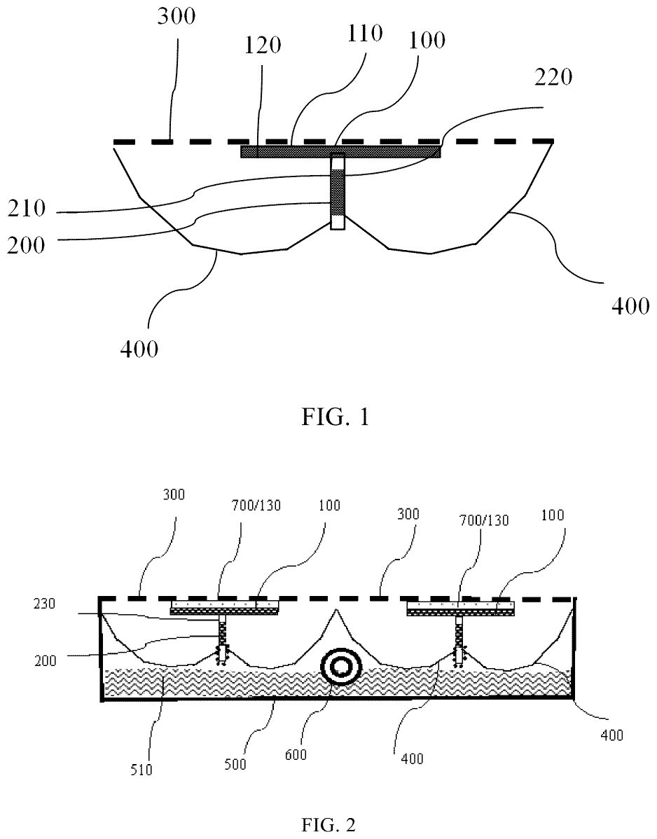

As shown in FIGS. 1-3, the solar energy utilization device includes a first double-sided light energy utilization unit 100, a second double-sided light energy utilization unit 200, a cover 300, and a concentrating mirror structure 400.

At least a portion of the cover 300 is transparent or semi-transparent. The first double-sided light energy utilization unit 100 is arranged on one side of the cover 300. Specifically, when the cover 300 is horizontally or nearly horizontally arranged, the first double-sided light energy utilization unit 100 may be arranged on the lower or upper side of the cover 300. Typically, the first double-sided light energy utilization unit 100 is arranged on the lower side of the cover 300, allowing the cover 300 to serve a dust-proof function and facilitate cleaning of the solar energy utilization device. When the cover 300 is vertically or nearly vertically arranged, the first double-sided light energy utilization unit 100 may be arranged on the left or right side of the cover 300.

The first double-sided light energy utilization unit 100 has a first light energy utilization part 110 and a second light energy utilization part 120 that are arranged in opposite directions. The first light energy utilization part 110 faces toward the cover 300, and the second light energy utilization part 120 faces away from the cover 300. Both the first light energy utilization part 110 and the second light energy utilization part 120 are configured to receive and convert solar energy. The second double-sided light energy utilization unit 200 similarly has a first light energy utilization part 210 and a second light energy utilization part 220 that are arranged in opposite directions.

In an embodiment, one end of the second double-sided light energy utilization unit 200 is connected to the first double-sided light energy utilization unit 100, and another end of the second double-sided light energy utilization unit 200 extends away from the first double-sided light energy utilization unit 100. In this embodiment, the first double-sided light energy utilization unit 100 and the second double-sided light energy utilization unit 200 may be disposed at an acute angle, right angle, or obtuse angle relative to each other.

The first light energy utilization parts 110, 210 and the second light energy utilization parts 120, 220 are configured to receive and convert solar energy. In one embodiment, the first double-sided light energy utilization unit 100 may be one or more of: a double-sided photovoltaic panel, a light energy utilization device, a photoelectric and thermal energy comprehensive utilization device, or a concentrating solar device, and/or the second double-sided light energy utilization unit 200 can similarly be one or more of the aforementioned devices. As used herein, photovoltaic panels generally refer to any device that directly converts light energy into electrical energy, including various semiconductor photovoltaic panels, photovoltaic films, quantum dot photoelectric conversion devices, etc. In other embodiments, the first double-sided light energy utilization unit 100 and the second double-sided light energy utilization unit 200 may also adopt other forms of solar energy utilization and conversion structures.

In an embodiment, the first double-sided light energy utilization unit 100 and the second double-sided light energy utilization unit 200 are arranged perpendicularly. The concentrating mirror structure 400 is at least partially arranged on the side of the first double-sided light energy utilization unit 100 away from the cover 300, and is configured to converge light onto: the second light energy utilization part 120 of the first double-sided light energy utilization unit 100, and either or both of the first light energy utilization part 210 and the second light energy utilization part 220 of the second double-sided light energy utilization unit 200. Specifically, the light convergence paths include: (i) the second light energy utilization part 120, the first light energy utilization part 210, and the second light energy utilization part 220; (ii) the second light energy utilization part 120 and the first light energy utilization part 210; or (iii) the second light energy utilization part 120 and the second light energy utilization part 220.

The concentrating mirror structure 400 may comprise any material with high reflectivity, such as a reflective film, mirrored aluminum, or a high-reflectivity coating applied to smooth metallic or plastic substrates.

In the prior art, individual vertically or horizontally arranged photovoltaic panels exhibit significant power generation efficiency variations throughout the day, resulting in unstable performance of solar energy utilization devices. During periods of substantial sunlight angle variation, these devices demonstrate relatively low average power generation and light energy utilization efficiency.

In contrast, the concentrating mirror structure 400 in the solar energy utilization device of the present application significantly improves adaptability to sunlight angle variations. Throughout the day, as sunlight strikes the device at different incident angles, the concentrating mirror structure 400 refracts and converges the light onto both the first double-sided light energy utilization unit 100 and the second double-sided light energy utilization unit 200. This optical arrangement results in reduced fluctuation in overall power generation efficiency across different time periods, enhanced stability in power generation performance, and increased average power generation along with improved light energy utilization efficiency over extended durations.

Furthermore, the present application configures both light energy utilization units with double-sided light-receiving capability. Even for the light energy utilization parts that are not directly illuminated by sunlight (such as the first light energy utilization part 210 and the second light energy utilization parts 120, 220 in FIG. 1), the concentrating mirror structure 400 refracts and converges light onto these light energy utilization parts, maximizing light energy utilization while enhancing the power generation capacity and light energy utilization efficiency of the solar energy utilization device. Additionally, light reflected from one light energy utilization unit can be reutilized by the other light energy utilization unit, further improving overall energy capture.

Furthermore, when the first double-sided light energy utilization unit 100 and the second double-sided light energy utilization unit 200 are arranged at a right angle relative to each other, this configuration provides distinct advantages over acute or obtuse angle arrangements. The right-angled arrangement enables both the first double-sided light energy utilization unit 100 and the second double-sided light energy utilization unit 200 to receive a greater amount of light converged by the concentrating mirror structure 400, thereby enhancing the average power generation and light energy utilization efficiency of the solar energy utilization device. Additionally, the right-angled configuration offers superior structural strength and facilitates manufacturing processes compared to alternative angular arrangements.

As illustrated in FIGS. 1-2, in an embodiment, one end of the second double-sided light energy utilization unit 200 is in thermal contact with the second light energy utilization part 120 of the first double-sided light energy utilization unit 100, enabling heat conduction from the first double-sided light energy utilization unit 100 to the second double-sided light energy utilization unit 200. Another end of the second double-sided light energy utilization unit 200 extends away from the first double-sided light energy utilization unit 100 and is in thermal contact with the concentrating mirror structure 400. This configuration allows heat from the first double-sided light energy utilization unit 100 to dissipate through the second double-sided light energy utilization unit 200, while the second double-sided light energy utilization unit 200 further transfers heat to the concentrating mirror structure 400 for additional dissipation, thereby preventing thermal damage to the first double-sided light energy utilization unit 100 or the second double-sided light energy utilization unit 200 caused by excessive temperatures.

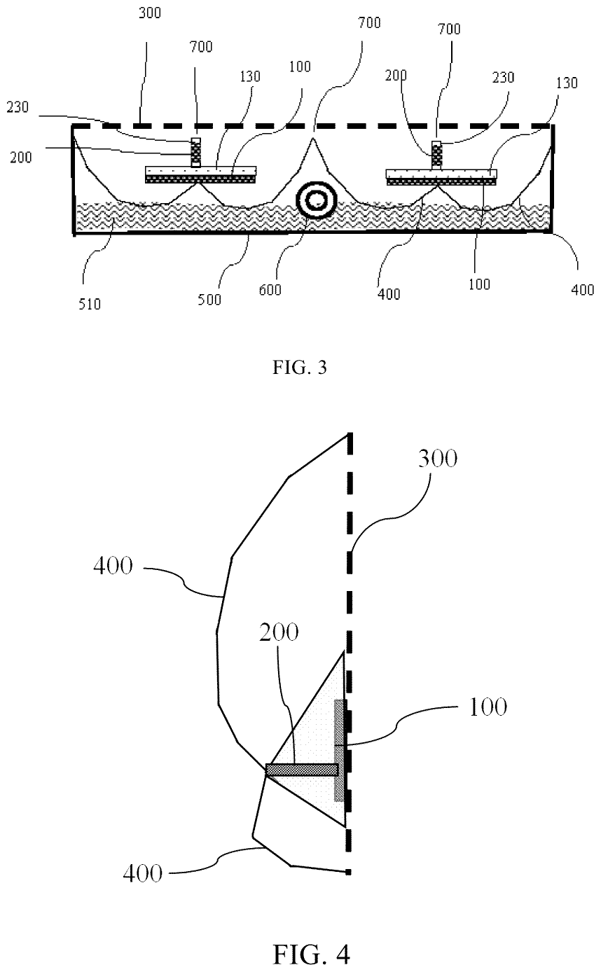

As shown in FIG. 3, in an embodiment, the second double-sided light energy utilization unit 200 is arranged between the first double-sided light energy utilization unit 100 and the cover 300. The end of the second double-sided light energy utilization unit 200 remote from the cover 300 is in thermal contact with the first light energy utilization part 110 of the first double-sided light energy utilization unit 100, while the second light energy utilization part 120 of the first double-sided light energy utilization unit 100 is in thermal contact with the concentrating mirror structure 400. This arrangement allows heat from the second double-sided light energy utilization unit 200 to dissipate through the first double-sided light energy utilization unit 100, which further transfers heat to the concentrating mirror surface 400, thereby enhancing the overall heat dissipation efficiency of both the first double-sided light energy utilization unit 100 and the second double-sided light energy utilization unit 200.

As shown in FIGS. 1 and 3, in an embodiment, the concentrating mirror structure 400 may be in thermal contact with the cover 300. This configuration utilizes both the concentrating mirror structure 400 and the cover 300 to reduce the overall thermal load and enhance the heat dissipation efficiency of the entire solar energy utilization device.

As shown in FIG. 2, in an embodiment, the solar energy utilization device may further include a cooling container 500 arranged on the side of the concentrating mirror structure 400 away from the cover 300. The cooling container 500 includes an accommodation tank for holding a cooling working fluid 510. The cooling working fluid 510, for example, may be tap water, deionized water, glycerol, or similar substances, typically at a temperature below the operating temperature of the solar energy utilization device. The concentrating mirror structure 400 is configured to contact the cooling working fluid 510 to transfer heat to the cooling working fluid 510. This allows the cooling working fluid 510 to dissipate heat from the concentrating mirror structure 400, thereby enhancing the overall heat dissipation efficiency of the solar energy utilization device.

Furthermore, in an embodiment, the accommodation tank may include an external interface 600 configured for inflow and outflow of the cooling working fluid 510. This interface enables heat exchange between the fluid and an external system, allowing simultaneous electricity generation and thermal energy utilization. For example, tap water absorbing heat from the solar energy utilization device becomes hot water that exits through the external interface 600 for user consumption.

Furthermore, as shown in FIG. 2, in an embodiment, the second double-sided light energy utilization unit 200 is in thermal contact with the concentrating mirror structure 400, with a perforation at their connection interface. This perforation allows the cooling working fluid 510 to directly contact the second double-sided light energy utilization unit 200, enabling direct heat transfer from the second double-sided light energy utilization unit 200 to the cooling working fluid 510, thereby significantly enhancing its heat dissipation efficiency.

As shown in FIG. 3, in an embodiment, the first double-sided light energy utilization unit 100 is in thermal contact with the concentrating mirror structure 400, with an opening at their connection interface. This opening allows the cooling working fluid 510 to directly contact the first double-sided light energy utilization unit 100, enabling direct heat transfer from the first double-sided light energy utilization unit 100 to the cooling working fluid 510, thereby significantly enhancing its heat dissipation efficiency.

In the structure of FIG. 1, the first light energy utilization unit 100 is arranged above the cover 300. When thermal utilization is not required, this configuration offers significant advantages as the first light energy utilization unit 100 can be in thermal contact with the cover 300, thereby using its large surface area of the cover 300 for efficient heat dissipate from the first light energy utilization unit 100. In contrast, the structure shown in FIG. 3 features the first light energy utilization unit 100 in direct thermal contact with the concentrating mirror structure 400, making it particular advantageous for thermal utilization applications such as heating the cooling working medium 510. In this case, the second light energy utilization unit may be thermally isolated from the cover 300 (or non-contacting), with air serving as an effective thermal isolation medium.

In an embodiment, the cover 300 and the concentrating mirror structure 400 collectively form a cavity for accommodating a cooling medium. Both the first double-sided light energy utilization unit and the second double-sided light energy utilization unit can directly transfer heat to the cooling medium, and the concentrating mirror structure 400 can also transfer heat to the cooling medium. Compared to the cooling container 500 arrangement, the cooling medium is arranged in the cavity, the cooling medium may be in more direct contact with the two light energy utilization units, making the heat dissipation efficiency of the two light energy utilization units higher. In this embodiment, the cooling medium needs to be transparent or semi-transparent to avoid compromising the light energy utilization efficiency of the solar energy utilization device.

To enhance thermal energy utilization efficiency and effectiveness, the solar energy utilization device may incorporate thermal isolation or heat transfer mechanisms. Specifically, as shown in FIG. 2, in an embodiment, the solar energy utilization device also includes a thermal functional layer 700 disposed on the cover 300, or between the cover and the first double-sided light energy utilization unit, or between the cover and the second double-sided light energy utilization unit, or between the cover and the concentrating mirror structure. This thermal functional layer is configured to block or facilitate heat transfer. Critically, at least a portion of the thermal functional layer 700 is transparent or semi-transparent to avoid compromising the light energy utilization efficiency of the solar energy utilization device.

The thermal functional layer 700 may comprise a transparent thermally conductive material to directly transfer heat from the first double-sided light energy utilization unit 100 or the second double-sided light energy utilization unit 200 to the cover 300, thereby enhancing heat dissipation. Alternatively, the thermal functional layer 700 may be a transparent heat-insulating material that prevents direct heat transfer of the first double-sided light energy utilization unit 100 or the second double-sided light energy utilization unit 200 to the cover 300, increasing internal heat of the solar energy utilization device and improving thermal energy utilization efficiency of the solar energy utilization device.

The thermal functional layer 700 includes, but is not limited to, materials such as transparent plastics, air, or thermally conductive glass and plastics.

As shown in FIGS. 2 and 3, the first double-sided light energy utilization unit 100 and the second double-sided light energy utilization unit 200 are typically arranged on a transparent carrier 130 or 230. Thus, when the first double-sided light energy utilization unit 100 or the second double-sided light energy utilization unit 200 is in contact with the cover 300 (as illustrated in FIG. 2), the thermal functional layer 700 may be integrated with the transparent carrier 130 of the first double-sided light energy utilization unit 100 or the transparent carrier 230 of the second double-sided light energy utilization unit 200. In the embodiment shown in FIG. 2, the thermal functional layer 700 is integrated with carrier 130. In other embodiments, the thermal functional layer 700 is separated from the transparent carriers of both the first double-sided light energy utilization unit 100 and the second double-sided light energy utilization unit 200. Consequently, the transparent carriers of the first double-sided light energy utilization unit 100 and the second double-sided light energy utilization unit 200 sometimes also serve heat transfer or heat insulation functions.

As shown in FIG. 1, in an embodiment, the first double-sided light energy utilization unit 100 is arranged on the surface of the cover 300 and is in thermal contact with the cover 300 via transparent adhesive, enabling heat transfer from the first double-sided light energy utilization unit 100 to the cover 300 for effective dissipation. In this embodiment, the thermal functional layer 700 comprises the transparent adhesive, serving as a heat conductor. The first double-sided light energy utilization unit 100 can be arranged parallel to the cover 300 to maximize the contact area between the first double-sided light energy utilization unit 100 and the cover 300, thereby further improving heat dissipation efficiency of the first double-sided light energy utilization unit 100. As shown in FIG. 3, in an embodiment, the first double-sided light energy utilization unit 100, the second double-sided light energy utilization unit 200, and the concentrating mirror structure 400 are all thermally isolated from the cover 300 by an air gap. In this embodiment, the thermal functional layer 700 comprises air, functioning as a thermal barrier. Heat from the first double-sided light energy utilization unit 100 and the second double-sided light energy utilization unit 200 can only be transferred to the cooling container 500 and its contained cooling working fluid 510 via the concentrating mirror structure 400.

As shown in FIG. 2, in another embodiment, part of the thermal functional layer 700 comprises transparent plastic disposed on the cover 300 to thermally insulate the first double-sided light energy utilization unit 100 from the cover 300, while another part comprises air that thermally insulates the cover 300 from the concentrating mirror structure 400. That is, this embodiment features two types of thermal functional layers 700: one is transparent plastic and the other is air. This configuration allows heat from the first double-sided light energy utilization unit 100 to be transferred solely through the second double-sided light energy utilization unit 200 to the concentrating mirror structure 400 and the cooling container 500 with its cooling working fluid 510.

In one embodiment, the cover 300 and the concentrating mirror structure 400 are enclosed to form a closed cavity to prevent dust ingress into the solar energy utilization device interior and significantly facilitate maintenance and cleaning operations.

In one embodiment, the first double-sided light energy utilization unit 100, the second double-sided light energy utilization unit 200, and the concentrating mirror structure 400 may exhibit a symmetrical configuration. In other embodiments, as shown in FIG. 4, the first double-sided light energy utilization unit 100, the second double-sided light energy utilization unit 200, and the concentrating mirror structure 400 can also adopt an asymmetrical arrangement to enhance adaptability to varying sunlight angles.

In one embodiment, as shown in FIGS. 1 and 4, the cover 300 and the first double-sided light energy utilization unit 100 may be configured in a horizontal or vertical arrangement. The vertical and horizontal directions mentioned in this embodiment and other embodiments are defined relative to the illustrated orientation. Since the solar energy utilization device may be reoriented based on terrain and latitude variations in practical applications, this illustrated orientation may be different from its actual deployment configuration of the solar energy utilization device.

In the embodiment illustrated in FIG. 4, both the cover 300 and the first double-sided light energy utilization unit 100 are vertically arranged, resulting in a vertical orientation for the entire solar energy utilization device. This configuration allows precipitation such as rainwater or snow to slide off more easily from the cover 300 and the concentrating mirror structure 400, thereby reducing maintenance efforts required for cleaning or sweeping.

It should be understood that, as shown in FIGS. 1-4, the spatial arrangement, interconnection relationships, and quantities of the above-mentioned first double-sided light energy utilization unit 100, second double-sided light energy utilization unit 200, cover 300, and concentrating mirror structure 400 can be variably configured. These elements can be adaptively combined with thermal contact, insulation, and utilization strategies to yield numerous alternative embodiment variations.

In actual manufacturing practice, the solar energy utilization devices of this application may be configured in array formations, with multiple solar energy utilization devices integrated collectively into a single array.

The specific embodiments described above are presented for the purpose of illustrating and understanding the present application, and are not to be construes as limiting it. Those skilled in the art may make various simple deductions, modifications, or substitutions based on the concepts of the present application.

1. A solar energy utilization device, comprising:
a cover, at least a portion of which is transparent or semi-transparent;
a first double-sided light energy utilization unit, arranged on one side of the cover, and having a first light energy utilization part and a second light energy utilization part that are arranged in opposite directions, wherein the first light energy utilization part of the first double-sided light energy utilization unit faces the cover;
a second double-sided light energy utilization unit, arranged perpendicularly to the first double-sided light energy utilization unit, and having a first light energy utilization part and a second light energy utilization part that are arranged in opposite directions, wherein the first light energy utilization part and the second light energy utilization part are configured to receive and convert solar energy; and
a concentrating mirror structure, at least a portion of which is arranged on a side of the first double-sided light energy utilization unit away from the cover, and which is configured to converge light onto the second light energy utilization part of the first double-sided light energy utilization unit, and onto the first light energy utilization part and/or the second light energy utilization part of the second double-sided light energy utilization unit.

2. The solar energy utilization device according to claim 1, wherein an end of the second double-sided light energy utilization unit is in thermal contact with the second light energy utilization part of the first double-sided light energy utilization unit to conduct heat from the first double-sided light energy utilization unit to the second double-sided light energy utilization unit; and another end of the second double-sided light energy utilization unit is extended away from the first double-sided light energy utilization unit and is in thermal contact with the concentrating mirror structure.

3. The solar energy utilization device according to claim 1, wherein the second double-sided light energy utilization unit is arranged between the first double-sided light energy utilization unit and the cover, an end of the second double-sided light energy utilization unit is in thermal contact with the first light energy utilization part of the first double-sided light energy utilization unit, and the second light energy utilization part of the first double-sided light energy utilization unit is in thermal contact with the concentrating mirror structure.

4. The solar energy utilization device according to claim 1, wherein the first double-sided light energy utilization unit is arranged on the cover and is in thermal contact or thermal isolation with the cover, or an end of the second double-sided light energy utilization unit is faced toward the cover so as to be in thermal contact or thermal isolation with the cover; the concentrating mirror structure is in thermal contact or thermal isolation with the cover.

5. The solar energy utilization device according to claim 1, further comprising a cooling container arranged on a side of the concentrating mirror structure away from the cover; wherein the cooling container is provided inside with an accommodation tank and an external interface; the accommodation tank is configured to accommodate a cooling working fluid; the external interface is configured for the cooling working fluid to enter and exit the accommodation tank; and the concentrating mirror structure is capable of being in contact with the cooling working fluid to transfer heat to the cooling working fluid.

6. The solar energy utilization device according to claim 5, wherein
the second double-sided light energy utilization unit is in thermal contact with the concentrating mirror structure;
or, the first double-sided light energy utilization unit is in thermal contact with the concentrating mirror structure.

7. The solar energy utilization device according to claim 6, wherein
a connection point where the second double-sided light energy utilization unit is in thermal contact with the concentrating mirror structure is provided with a perforation, wherein the perforation is configured for the cooling working fluid to come into contact with the second double-sided light energy utilization unit, so that the second double-sided light energy utilization unit is capable of directly transferring heat to the cooling working fluid;
or, a connection point where the first double-sided light energy utilization unit is in thermal contact with the concentrating mirror structure is provided with an opening, wherein the opening is configured for the cooling working fluid to come into contact with the first double-sided light energy utilization unit, so that the first double-sided light energy utilization unit is capable of directly transferring heat to the cooling working fluid.

8. The solar energy utilization device according to claim 1, wherein the cover and the concentrating mirror structure are enclosed to form a cavity, wherein the cavity is configured for accommodating a cooling medium; and the first double-sided light energy utilization unit and the second double-sided light energy utilization unit are capable of transferring heat to the cooling medium.

9. The solar energy utilization device according to claim 1, further comprising a thermal functional layer, wherein at least a portion of the thermal functional layer is transparent or semi-transparent; the thermal functional layer is arranged on the cover, or arranged between the cover and the first double-sided light energy utilization unit, or arranged between the cover and the second double-sided light energy utilization unit, or arranged between the cover and the concentrating mirror structure; the thermal functional layer is configured to block or connect heat transfer.

10. The solar energy utilization device according to claim 1, wherein
the cover and the concentrating mirror structure are enclosed to form a closed accommodation cavity.

11. The solar energy utilization device according to claim 1, wherein
the first double-sided light energy utilization unit, the second double-sided light energy utilization unit, and the concentrating mirror structure are arranged in an asymmetric shape; and
the cover and the first double-sided light energy utilization unit are both horizontally or vertically arranged.

12. A solar energy utilization device, comprising:
a cover, at least a portion of which is transparent or semi-transparent;
a first double-sided light energy utilization unit, arranged on the cover, and having a first light energy utilization part and a second light energy utilization part that are arranged in opposite directions; wherein the first light energy utilization part is faced toward the cover;
a second double-sided light energy utilization unit, having an end connected to the first double-sided light energy utilization unit and another end extended in a direction away from the first double-sided light energy utilization unit; wherein the second double-sided light energy utilization unit has a first light energy utilization part and a second light energy utilization part that are arranged in opposite directions and are configured to receive and convert solar energy; and
a concentrating mirror structure, at least part of which is arranged on a side of the first double-sided light energy utilization unit away from the cover, and which is configured for concentrating light onto the second light energy utilization part of the first double-sided light energy utilization unit, and onto the first light energy utilization part and/or the second light energy utilization part of the second double-sided light energy utilization unit, and the concentrating mirror structure is in thermal contact with the second double-sided light energy utilization unit.

13. A solar energy utilization device, comprising:
a cover, at least a portion of which is transparent or semi-transparent;
a first double-sided light energy utilization unit, having a first light energy utilization part and a second light energy utilization part that are arranged in opposite directions; wherein the first light energy utilization part is faced toward the cover;
a second double-sided light energy utilization unit, being perpendicular to the first double-sided light energy utilization unit, and arranged between the first double-sided light energy utilization unit and the cover, wherein an end of the second double-sided light energy utilization unit is connected to the first double-sided light energy utilization unit, and another end is extended in a direction away from the first double-sided light energy utilization unit; the second double-sided light energy utilization unit has a first light energy utilization part and a second light energy utilization part that are arranged in opposite directions and are configured to receive and convert solar energy; and
a concentrating mirror structure, at least part of which is arranged on a side of the first double-sided light energy utilization unit away from the cover, wherein the concentrating mirror structure is configured to converge light onto the second light energy utilization part of the first double-sided light energy utilization unit, as well as onto the first light energy utilization part and/or the second light energy utilization part of the second double-sided light energy utilization unit, and the concentrating mirror structure is in thermal contact with the first double-sided light energy utilization unit.
